(19) United States
(12) Patent Application Publication
(10) Pub. No.: US 2006/0158674 A1
(43) Pub. Date: Jul. 20, 2006

(54) Printer driver, information processing device including the same, print control device, and print data generating method

(76) Inventor: Yoshihiro Mizoguchi, Yamatokooriyama-shi (JP)

Correspondence Address: MARK D. SARALINO (GENERAL);RENNER, OTTO, BOISSELLE & SKLAR, LLP, 1621 EUCLID AVENUE, NINETEENTH FLOOR, CLEVELAND, OH, 44115-2191, US

(21) Appl. No.: 11/326,151

(22) Filed: Jan. 5, 2006

(30) Foreign Application Priority Data
Jan. 14, 2005 (JP) 2005-008073

(51) Int. Cl. G06F 3/12

(52) U.S. Cl. 358/1.13

(57) ABSTRACT

a printer driver including: a user interface acquisition section for acquiring from an external print control device a user interface for allowing a user to make provisional print settings; a set value transmission section for transmitting to the print control device the provisional print settings using the user interface; and a print data generation section for acquiring ultimate print settings prepared on the basis of the provisional print settings transmitted to and in the print control device and for generating print data on the basis of the acquired ultimate print settings to transmit the print data to the print control device.

### CROSS-REFERENCE TO RELATED APPLICATION

This application is related to Japanese application No. 2005-8073 filed on Jan. 14, 2005 whose priority is claimed under 35 USC §119, the disclosure of which is incorporated by reference in its entirety.

### BACKGROUND OF THE INVENTION

1. Field of the Invention

The present invention relates to a printer driver, an information processing device including the same, a print control device, and a print data generating method.

2. Description of the Related Art

There have been known some methods for enabling a user to make a print setting for a print device connected to a network for performing a printing process, from a plurality of terminals which can communicate with the print device through the network, without performing specific operations.

The print setting made to the aforementioned print device by the user makes sense only when the contents of the print setting can be processed by the print device. Accordingly, it is preferable that a setting screen for the print setting accurately reflects the structure and state of the print device. However, if the terminal receives/transmits information from/to the print device each time the setting screen is displayed, this will increase the amount of information communicated through the network. Also, it is necessary that both a printer driver and the print device include processes for reception/transmission of information, thus involving complicated software for realization of such processes. There have been disclosed methods which can suppress the amount of communicated information and can avoid increase of the number of software designing processes.

As one of the methods, there is disclosed a method which downloads, in advance, print setting information as a World Wide Web page from a print controller, in order to reduce the amount of information communicated between a client computer and the print controller (refer to, for example, Japanese Unexamined Patent Publication No. 2000-105676). Also, there is disclosed a method in which print settings are made on a web page with a means referred to as a job ticket and the print settings are transmitted to a server together with print information (refer to, for example, Japanese Unexamined Patent Publication No. 2003-76525).

According to the method disclosed in Japanese Unexamined Patent Publication No. 2000-105676, the print setting information is acquired through a World Wide Web page (also referred to as a web page) prior to the processing of the print setting. However, the print setting information is the number of print copies, the paper size and the like. Thus, it is not disclosed that the printer driver acquires and processes information about the structure of the print device which relates to the generation of print data. Further, the printer driver can not address the change of the print setting associated with changes of the state such as changes of optional structure of the print device or exhaustion of paper.

According to the method disclosed in Japanese Unexamined Patent Publication No. 2003-76525, print information is generated with a printer driver and then the print settings for a printer used for actual printing are made on a web page and then stored as a job ticket while the print setting is changed and a finisher and the like are controlled in a server according to the determined print setting. However, since the print settings are made after the generation of print information, it is impossible to change settings about the generation of print information such as enlarging or contracting of the content of printing, the changing of resolution and the changing of the font downloading method.

There has been a need for a printer driver capable of generating print data which properly reflects the restriction due to the structure and state of a print device. Further, it is preferable that client PCs in which printer drivers are operated are consistent with a plurality of operating systems (OSs) such as Windows (trademark), Macintosh, Linux (trademark). However, in such a case, these client PCs must incorporate processes reflecting the structure and state of the print device. If such processes are different depending on the OS, the number of designing processes will be the number of such processes multiplied by the number of corresponding OSs. In order to facilitate the maintenance after releasing and prevent the occurrence of bugs such as differences in detailed processes among OSs, there is a need for a structure which enables integrating processes for different OSs.

Further, to cope with the aforementioned printer driver, there is a need for a print control device which can acquire information about the structure and state of a print device and can provide a print setting screen properly reflecting the content of the structure and state thereof.

### SUMMARY OF THE INVENTION

The present invention provides a printer driver including: a user interface acquisition section for acquiring from an external print control device a user interface for allowing a user to make provisional print settings; a set value transmission section for transmitting to the print control device the provisional print settings using the user interface; and a print data generation section for acquiring ultimate print settings prepared on the basis of the provisional print settings transmitted to and in the print control device and for generating print data on the basis of the acquired ultimate print settings to transmit the print data to the print control device.

The present invention also provides a print control device including: an information acquisition section for acquiring information on a structure or state of a print device for printing out print data; a user interface management section for preparing a user interface which allows a user to make provisional print settings for printing out the print data by the print device on the basis of the acquired information, receiving from an external printer driver the provisional print settings using the prepared user interface, deciding ultimate print settings on the basis of the acquired information and the received provisional print settings, and providing the decided ultimate print settings to the printer driver; a user interface supply section for providing the user interface prepared by the user interface management section to the printer driver; and a print data processing section for acquiring print data generated by the printer driver on the basis of the ultimate print settings to make the print device to print out the print data.

From a different viewpoint, the present invention also provides a print data generating method for causing a computer to execute the steps of: acquiring from an external print control device a user interface for allowing a user to make provisional print settings; transmitting to the print control device the provisional print settings using the acquired user interface; acquiring from the print control device ultimate print settings decided by the print control device on the basis of the transmitted provisional print settings; and generating print data according to the acquired ultimate print settings.

### BRIEF DESCRIPTION OF THE DRAWINGS

FIG. 1 is an explanatory view illustrating the structure of a system including a plurality of client PCs to which a printer driver according to the present invention is installed and a printer controller which is a print control device according to the present invention, which are connected to one another through a network;

FIG. 2 is a block diagram illustrating an exemplary hardware structure of a client PC 200 of FIG. 1;

FIG. 3 is a block diagram illustrating an exemplary hardware structure of a printer controller 203 of FIG. 1;

FIG. 4 is a flowchart illustrating, with a central focus on a UI display section 212 of FIG. 1, a process procedure for making the print setting in the client PC 200 of FIG. 1;

FIG. 5 is a flowchart illustrating, with a central focus on the UI display section 212, a process procedure executed after the UI display section 212 of FIG. 1 receives a request for start of a printing process;

FIG. 6 is a flowchart illustrating a process procedure which a printer driver UI 240 in the printer controller 203 of FIG. 1 executes in making the print setting;

FIG. 7 is a flowchart illustrating a process procedure in the case where a setting change section 246 of FIG. 1 integrally changes the print setting settings;

FIG. 8 is an explanatory view illustrating an exemplary UI screen displayed on a display device 108 of the client PC 200 of FIG. 1;

FIG. 9 is an explanatory view illustrating an exemplary content of a UI combination restriction table 243 of FIG. 1; and

FIG. 10 is a flowchart illustrating a process procedure which a printer driver 211 for Windows executes on receiving a request for generation of print data the UI display section 212 of FIG. 1.

### DESCRIPTION OF THE PREFERRED EMBODIMENTS

The printer driver according to the present invention includes a user interface acquisition section for acquiring from an external print control device a user interface for allowing a user to make provisional print settings, a set value transmission section for transmitting to the print control device the provisional print settings using the user interface, and a print data generation section for acquiring ultimate print settings prepared on the basis of the provisional print settings transmitted to and in the print control device and for generating print data on the basis of the acquired ultimate print settings to transmit the print data to the print control device. This enables utilizing a common user interface among printer drivers that operate in different types of OS environments, in order to enable users to make print settings. This can avoid improper print outputting due to inconsistency between information in the printer drivers in the client PCs and the state of the print device or the states of optional devices connected thereto through a network.

Further, the print control device according to the present invention includes an information acquisition section for acquiring information on a structure or state of a print device for printing out print data, a user interface management section for preparing a user interface which allows a user to make provisional print settings for printing out the print data by the print device on the basis of the acquired information, receiving from an external printer driver the provisional print settings using the prepared user interface, deciding ultimate print settings on the basis of the acquired information and the received provisional print settings, and providing the decided ultimate print settings to the printer driver; a user interface supply section for providing the user interface prepared by the user interface management section to the printer driver; and a print data processing section for acquiring print data generated by the printer driver on the basis of the ultimate print settings to make the print device to print out the print data. This enables providing a common user interface to printer drivers that operate in different types of OS environments, in order to enable users to make print settings using the user interface. Further, in cases where the structure of the print device is changed, it is only required that the user interface is updated in the print control device, which requires no operations for updating or setting change of the printer drivers in the respective client PCs, thereby enabling integral management. Further, this enables making the print setting consistent with the state of the print device or the structures of optional devices and the like in the case where the print setting made in the printer driver is inconsistent therewith. This can avoid improper print outputting due to inconsistency between the print setting and the state and structure of the print device.

According to the present invention, a print setting process is divided into a processing section relating to user interfaces (user interface acquisition section) on a client PC side and another processing section (print data generation section), a print control device provides a common user interface to respective printer driver main bodies which operate in a plurality of client PCs, and a UI display section displays the acquired user interface on a screen. Further, the print control device integrally processes the checking of consistency between the print settings which the user made on the displayed user interface screen and the structure and state of a print device.

Therefore, the printer driver according to the present invention includes a user interface acquisition section for acquiring from an external print control device a user interface for allowing a user to make provisional print settings, a set value transmission section for transmitting to the print control device the provisional print settings using the user interface, and a print data generation section for acquiring ultimate print settings prepared on the basis of the provisional print settings transmitted to and in the print control device and for generating print data on the basis of the acquired ultimate print settings to transmit the print data to the print control device.

In the aforementioned printer driver, the print setting is conditions relating to generation, processing and outputting of print data which are set according to the user's intension, depending on the structure and state of a print device, when print data generated by the printer driver is processed by the print control device and then output and printed from the print device. For example, the print setting is the number of print copies, paper size, designation of paper feed tray, designation of 1 sided (simplex) printing or 2 sided (duplex) printing and designation of finishing such as staple which depend on the optional structures and the like of the print device. However, the print setting is not limited to them. The print setting may be changes of the print density, the enlargement/contraction, the resolution and setting of font-downloading method. Alternatively, the print setting may be conditions relating to the state of the print device such as temporal impossibility of utilization of optional devices due to failure thereof or exhaustion of papers with certain sizes.

Further, the user interface is an environment which is provided to the user for enabling the user to perform an operation for making the print setting and, for example, the user interface is the details of a setting screen displayed on a client computer. The printer driver acquires information input on the setting screen by the user.

The user interface acquisition section may function as a web browser and acquires the user interface prepared as a web page from the print control device. With this structure, the print setting screen may be described in an HTML and stored in the print control device, the print device may function as a web server, and client PCs may display the print setting screen as a web page. With this structure, a plurality of client PCs incorporating different OSs and hardware may acquire a user interface from a single web server (print device) and may acquire a common interface. Accordingly, a common interface is provided to users and a designer can reduce the number of designing processes in comparison with cases of preparing individual user interfaces for respective OSs.

Conventionally, in changing optional structures of a print device or updating of the version of a user interface, there have been needs for performing operations for changing the settings of respective client PCs and for re-installing printer drivers in respective client PCs. However, with the present invention, it is only required that the user interface is changed in the print control device, which enables unification of changing operations, thereby resulting in reduction of the burden on the user. This can reduce errors during operations, thereby enabling provision of reliable user interfaces.

Further, the user interface acquisition section may acquire a user interface related to a structure of a print device for printing out the print data transmitted to the print control device. This enables making the print setting on the basis of the user interface reflecting the structure of the print device, which enables making the print setting consistently with the state of the print device or the structures of optional devices, thereby avoiding improper print outputs due to inconsistency between the print settings and the structure of the print device. From this viewpoint, it is possible to provide reliable printing processes.

Further, an information processing device according to the present invention includes the printer drivers, which can avoid improper print outputting due to inconsistency between the structure of the print device and the information in the printer driver and also can provide a user interface common to printer drivers in different OS environments.

Further, the print control device according to the present invention includes an information acquisition section for acquiring information on a structure or state of a print device for printing out print data, a user interface management section for preparing a user interface which allows a user to make provisional print settings for printing out the print data by the print device on the basis of the acquired information, receiving from an external printer driver the provisional print settings using the prepared user interface, deciding ultimate print settings on the basis of the acquired information and the received provisional print settings, and providing the decided ultimate print settings to the printer driver, a user interface supply section for providing the user interface prepared by the user interface management section to the printer driver, and a print data processing section for acquiring print data generated by the printer driver on the basis of the ultimate print settings to make the print device to print out the print data.

The user interface supply section may function as a web server and provides the user interface prepared as a web page to the printer driver. With this structure, the print setting screen may be described in an HTML and stored in the print control device while the print setting screen may be acquired and displayed by the web browser in a client PC. With this structure, a plurality of client PCs incorporating different OSs and hardware may acquire a user interface from a single web server (print device) and may acquire a common user interface. Accordingly, a common interface is provided to users and a designer can reduce the number of designing processes in comparison with cases of preparing individual user interfaces for respective OSs.

Conventionally, in changing optional structures of a print device or updating of the version of a user interface, there have been needs for performing operations for changing the settings of respective client PCs and for re-installing printer drivers in respective client PCs. However, with the present invention, it is only required that the user interface is changed in the print control device, which enables unification of changing operations, thereby resulting in reduction of the burden on the user. This can reduce errors during operations, thereby enabling provision of reliable user interfaces.

The user interface management section may prepare the user interface according to the structure or state of the print device. At this time, the structure of the print device refers to structures relating to print settings which can be processed by the print device. For example, the structure of the print device includes the number of trays usable for outputting, availability/unavailability of duplex printing, presence/absence of finishing functions such as staple. Also, the structure of the print device may include structures relating to the processing capacity such as the capacity of an image memory, the printing speed. This enables making the print setting on the basis of the user interface reflecting the structure of the print device, which enables making the print setting consistently with the state of the print device or the states of optional devices, thereby avoiding improper print outputting due to inconsistency between the print settings and the structure of the print device. From this viewpoint, it is possible to provide reliable printing processes.

Further, the print control device may further include a setting change section for changing an item or range of the print settings to be made using the user interface, and the user interface management section may be constructed to prepare the user interface in which the item or range of the print settings is changed according to an instruction from the setting change section. With this structure, for example, in an office environment in which a plurality of client PCs are connected to a print device through a network, when an administrator desires to manage the office environment such that the print device prints out a watermark on every paper or a department managing function is kept to be ON, the print settings for the respective client PCs can be unified through the setting of the user interface in the print control device. As described above, it is possible to integrally change the print setting for all client PCs which perform printing through a corresponding print control device.

Also, the user interface management section may prepare a common user interface for printer drivers of a plurality of information processing devices that operate in different types of operating system environments. It is possible to provide a structure capable of providing a common user interface by, for example, defining a specific rule, as well as by describing the user interface in an HTML. This enables a plurality of client PCs incorporating different OSs and hardware to acquire a common user interface from the print device. Accordingly, a common interface is provided to users and a designer can reduce the number of designing processes in comparison with cases of preparing individual user interfaces for respective OSs. This can integrate managing operations associated with version updating and the like, thereby reducing the burden. This can reduce errors during operations, thereby providing reliable user interfaces.

Hereinafter, the present invention will be described in more detail using the drawings.

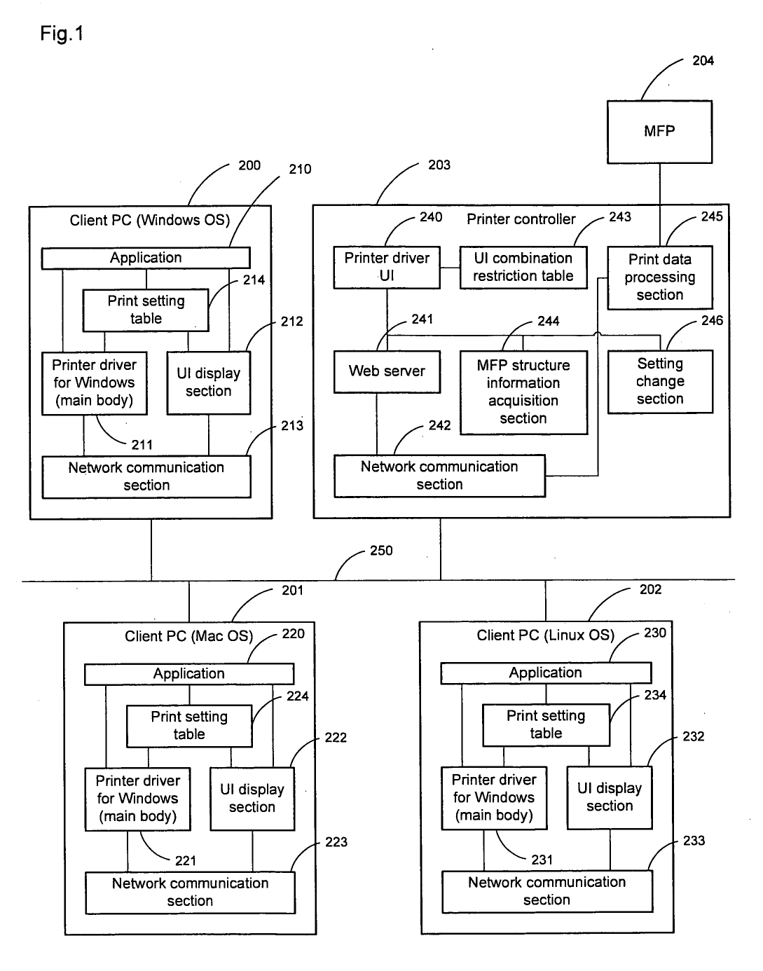

FIG. 1 is an explanatory view illustrating the structure of a system including a plurality of client PCs to which a printer driver according to the present invention is installed and a printer controller which is a print control device according to the present invention, which are connected to one another through a network. Also, from another viewpoint, FIG. 1 is an explanatory view of a system including an information processing device including the printer controller according to the present invention and the print control device connected to the information processing device through the network.

As illustrated in FIG. 1, a client PC 200 incorporates a Windows OS and, various types of application software 210 used for document processing or graphics drawings run on the OS. Further, the client PC 200 is constituted by a UI (User Interface) display section 212 which, when a user issues a request for execution of a printing process on an application, receives a request for start of a printing process from the application 210 through the OS and executes a process for displaying a user interface (hereinafter, referred to as UI), a print setting table 214 which stores print settings which have been set, and a printer driver 211 for Windows for generating print data under a determined print setting. The UI display section 212 corresponds to the user interface acquisition section and the printer driver 211 for Windows corresponds to the print data generation section.

On receiving a request for start of printing, the UI display section 212 acquires information about a UI screen, from a printer driver UI 240 in a printer controller 203 connected thereto through a network 250, through a network communication section 213. The UI display section 212 which has received the information displays the UI screen according to the acquired information. Further, the UI display section 212 transmits print setting determined by the user on the displayed UI screen, to the printer driver UI 240, causes the printer driver UI 204 in the printer controller 203 to check the consistency between the print setting and the structure or state of an MFP 204, and controls the printer driver 211 for Windows such that it generates print data under a print setting consistent therewith. The network communication section 213 corresponds to the set value transmission section.

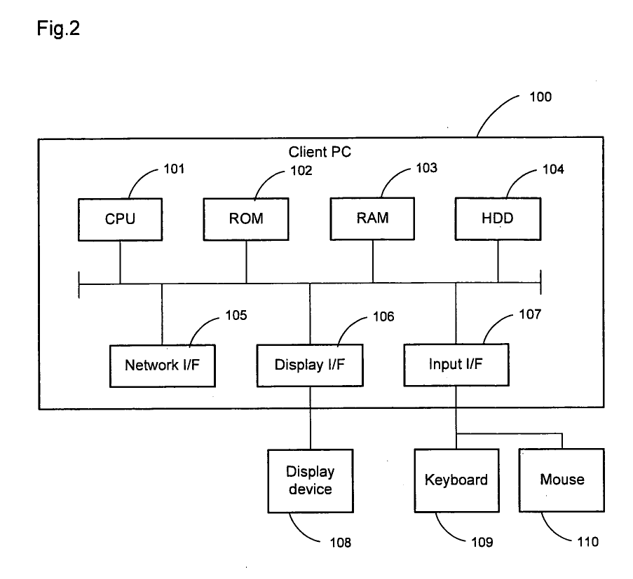

FIG. 2 is a block diagram illustrating an exemplary hardware structure of the client PC 200 of FIG. 1. As illustrated in FIG. 1, the client PC 200 is constituted by a CPU 101 for executing program processes for the Windows OS, applications and the printer driver, a ROM 102 for storing programs for a BIOS, self-diagnoses and the like, a RAM 103 which provides work areas for execution of programs by the CPU, an HDD (Hard Disk Drive) 104 for storing programs and data, a network I/F 105 for communication through the network 250, a display I/F 106 connected to a display device 108 for displaying screens for applications or the driver UI, a keyboard 109 and a mouse 110 used for inputting print settings and the like, and an input I/F 107 for connecting the keyboard 109 and the mouse 110 to the client PC 200. The applications 210, the printer driver 211 for Windows, the UI display section 212 and the network communication section 213 illustrated in FIG. 1 are stored in the HDD 104 as programs to be executed by the CPU 101 in FIG. 2. The processes executed by the UI display section 212 include the control of the display I/F 106. The processes executed by the network communication section 213 include the control of the network I/F 105.

The printer controller 203 illustrated in FIG. 1 is constituted by the following blocks. Namely, the printer controller 203 is constituted by the printer driver UI 240 which functions as a user interface management section for client PCs, prepares the details of web pages described in HTML, firmly determines the consistency between the determined print settings and combination restriction information, a web server 241 which functions as a user interface supply section, and provides the contents of web pages prepared by the printer driver UI 240 to client PCs, a network communication section 242 for communication through the network 250, an MFP structure information acquisition section 244 which functions as an information acquisition section, and acquires information about the structure or state of the MFP 204 which is a print device, a UI combination restriction table 243 which stores information about restriction on the functions of the UI and the combination of the functions thereof, and stores the information about the structure of the MFP 204 acquired by the MFP structure information acquisition section 244 and information about restriction on the combination of the structure and state of the MFP 204, a print data processing section 245 which functions as a printing processing section, and causes the MFP 204 to print out print data consistent with the firmly determined print setting, and a setting change section 246 for changing the details of the print setting and settable details.

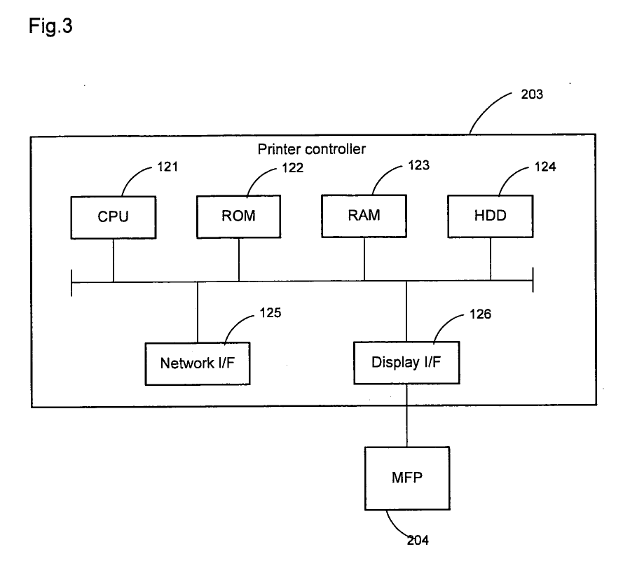

FIG. 3 is a block diagram illustrating an exemplary hardware structure of the printer controller 203 of FIG. 1. As illustrated in FIG. 3, the printer controller 203 is constituted by a CPU 121 which executes programs, the web server 241, the network communication section 242, the MFP structure information acquisition section 244, a ROM 122 which stores programs for realizing the functions of the print data processing section 245, a RAM 123 which provides an image memory and work areas for execution of programs by the CPU, a HDD (Hard Disk Drive) 124 which stores fonts and print data, a network I/F 125 for communication through the network 250, and an MFP I/F 126 for receiving from/transmitting to the MFP 204, print data and the structure and state of the MFP 204.

Client PCs 201 and 202 are client PCs connected to the network 250 to which the client PC 200 is connected. While the client PC 200 incorporates a Windows OS, the client PC 201 incorporates a Macintosh (trademark) OS and the client PC 202 incorporates a Linux OS. Accordingly, the printer driver (main body) in the client PC 201 is a printer driver 221 for Macintosh which is different from the printer driver 211 for Windows. The printer driver (main body) in the client PC 202 is a printer driver 231 for Linux which is different from the printer driver 211 for Windows. The UI display section 222 in the client PC 201 is different from the UI display section 212 in the client PC 200, and the UI display section 232 in the client PC 202 is different from the UI display section 212 of the client PC 200.

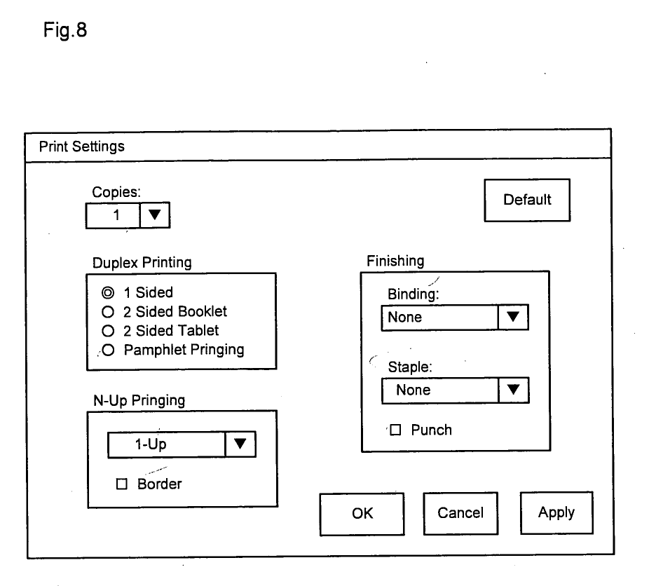

However, the printer driver 211 for Windows, the printer driver 221 for Macintosh and the printer driver 231 for Linux acquire UI from the web server 241 in the printer controller 204, through the network 250 and, therefore, the UI is common to them. FIG. 8 is an explanatory view illustrating an exemplary UI screen displayed on the display device 108 of the client PC 200 of FIG. 1. The UI screen 300 is a web page which displays details based on description of HTML prepared by the printer driver UI 240.

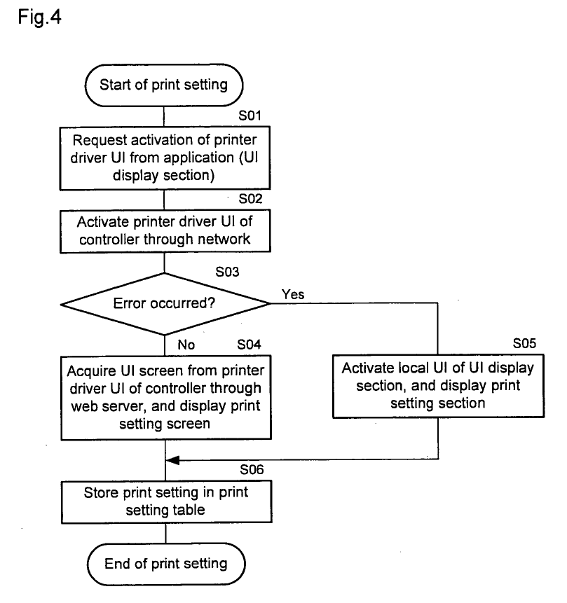

FIG. 4 is a flowchart illustrating, with a central focus on the UI display section 212, a process procedure for making the print setting, in the case where a user issues a request for a process for printing data of the application 210 being executed in the client PC 200. When the user selects a “print” menu in the application, the application transmits a request for start of a printing process to the UI display section 212 through the Windows (step S01). On receiving the request, the UI display section starts a process for displaying a window for making the print setting, namely a UI screen as illustrated in FIG. 8.

First, the UI display section 212 requests the printer driver UI 240 of the printer controller 203 connected thereto through the network to provide the details of display of the UI screen (step S02). In the event of the occurrence of an error in the UI from the printer driver UI 240 at this time, such as failure of the communication with the printer controller 203, the routine proceeds to step S05 where the UI display section 212 itself prepares the details of the UI screen and displays them on the screen of the client PC 200. On the other hand, when the printer driver UI 240 can successfully receive the request, the routine proceeds to step S04 where the printer driver UI 240 prepares the details of display of the UI screen.

The printer driver UI 240 prepares the details of display of the UI screen in HTML and the web server 241 provides the details of display of the UI screen described in HTML to the client PC 200. The UI display section 212 displays the provided UI screen on the display device 108. The user makes the print setting by using the displayed UI screen.

Taking the UI screen 300 in FIG. 8 as an example, there are displayed, as print setting items to be made by a user, “Copies” for setting the number of copies to be printed, “Duplex printing” for selecting the type of printing from 1 sided printing and 2 sided printing, “Finishing” for designating the type of finishing, “N-Up Printing” for selecting the number of print data pages to be printed in a single printing paper, and the like. By using the displayed UI screen 300, the user inputs setting of printing which he/she requires. It is assumed that the setting in the UI screen 300 is the result of setting made by the user. Namely, “Copies” is set to 1, “Duplex Printing” is set to “1 Sided” (simplex). Further, “Staple”, which is a detailed setting of “Finishing”, is set to “None” and also “Binding” is not selected and, therefore, no specific processing will be performed. Further, “N-Up Printing” is set to “1-Up”, namely a single print-data page is printed on a single printing paper. The aforementioned settings are settings required by the user. According to the change of condition settings made by the user, the printer driver UI 240 checks whether or not the setting is consistent with the structure or state of the MFP 204. Processes executed by the printer driver UI 240 will be described in detail later.

On recognizing that the user has pushed an “OK” button, the UI display section 212 stores the details of print setting in a print setting table 214 and completes the print setting process.

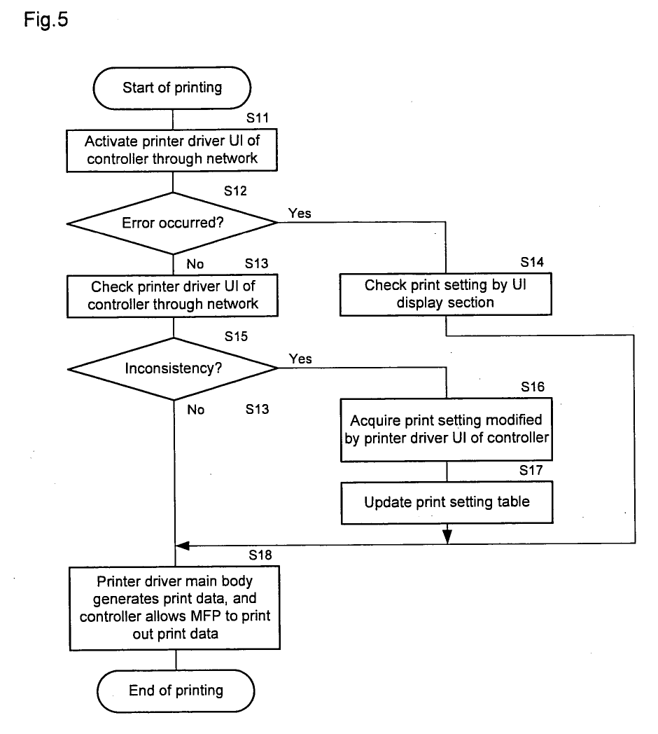

FIG. 5 is a flowchart illustrating, with a central focus on the UI display section 212, the process procedure executed after the “OK” button is pushed on the UI screen 300 of FIG. 8 to start a printing process. The UI display section 212 requests the printer driver UI 240 to check the determined print setting, through the network 205 (step S11). In the event of the occurrence of an error in the UI from the printer driver UI 240 at this time, such as failure of communication with the printer controller 203, the routine proceeds to step S14 where the UI display section 212 checks the print setting. On the other hand, when the printer driver UI 240 successfully receives the request, the routine proceeds to step S13 where the printer driver UI 240 checks whether or not the print setting is consistent with the structure or state of the MFP 204. The process executed by the printer driver UI 240 at this time will be described in detail later.

When the printer driver UI 240 determines that the print setting has inconsistency therewith, the routine proceeds to S16 where the UI display section 212 acquires print settings modified by the printer driver UI 240 (step S16) and updates a print setting table (step S17), and then the routine proceeds to step S18. On the other hand, when there is no inconsistency, the routine proceeds to S18 where the UI display section 212 requests the printer driver 211 for Windows to generate print data and send it to the printer controller 203 (step S18).

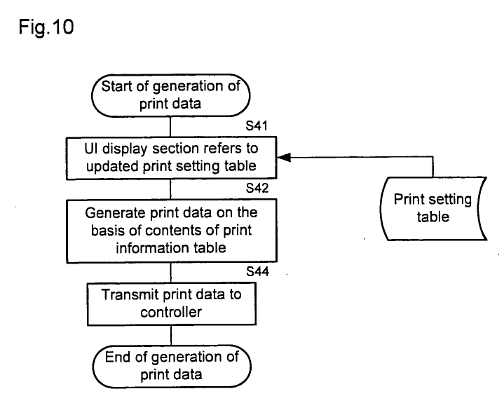

FIG. 10 is a flowchart illustrating a process procedure which the printer driver 211 for Windows executes on receiving the aforementioned request for generation of print data. As illustrated in FIG. 10, the printer driver 211 for Windows refers to the details of the print setting table 214 updated by the UI display section 212 (step S41) and generates print data on the basis of the details of the print setting table 214 (step S42). Then, the printer driver 211 for Windows transmits the generated print data to the print data processing section 245 in the printer controller 203 and causes the MFP 204 to print out it.

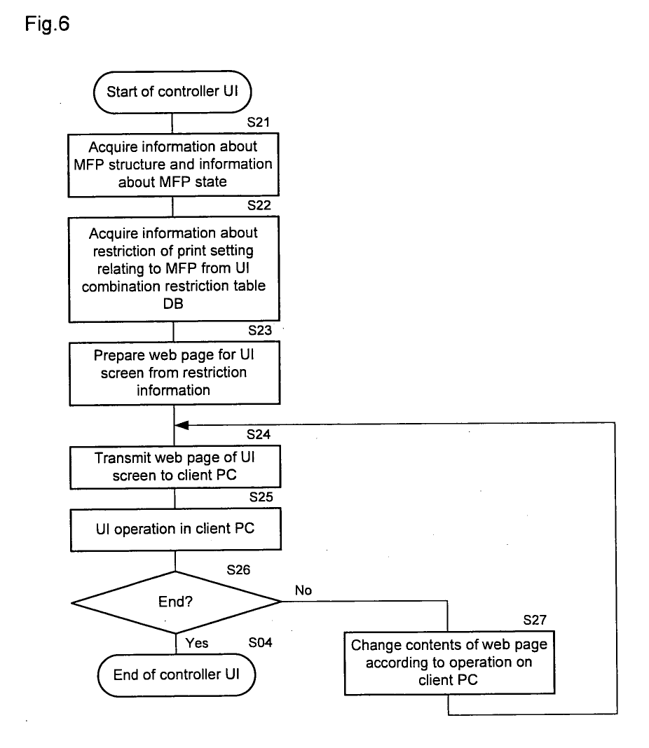

FIG. 6 is a flowchart illustrating a process procedure which the printer driver UI 240 in the printer controller 203 executes in making the print setting. As illustrated in FIG. 6, when the printer driver UI 240 receives a request for providing the details of display on the UI screen, from the UI display section 212 in the client PC 200, the printer driver UI 240 requests the MFP structure information acquisition section 244 to acquire information about the current structure of the MFP 204 and information about the state of the MFP 204 (step S21). In response to the request, the MFP structure information acquisition section 244 acquires information from the MFP 204. Next, the printer driver UI 240 acquires information about restriction on the functions of the print settings and the combination of functions, from the UI combination restriction table 243 (step S22). Then, referring to the information about the structure of the MFP 204, the information about the state of the MFP 204 and the information about the restriction on the combination, the printer driver UI 240 prepares a web page for the UI screen (step S23). The prepared UI screen is provided from the web server 241 to the UI display section 212 which issued the request for the UI screen (step S24).

The UI display section 212 displays the acquired details of display on the screen, and the user of the client PC 200 makes the print setting using the displayed UI screen. When the user operates on the UI screen, the printer driver UI 240 receives information about the operation from the UI display section 212 and determines, on the basis of the operation, whether or not the UI processing should be completed (step S26). When it should not be completed, if the UI screen must be changed in accordance with the inputs made by the user made on the UI screen, the printer driver UI 240 prepares a web page for the changed UI screen (step S27), and the web server 241 provides the changed UI screen to the UI display section 212. On the other hand, when the printer driver UI 240 receives, from the UI display section 212, information about the fact that the user of the client PC 200 has pushed the “OK” button on the UI screen, the printer driver UI 240 determines in step S26 that the print setting should be completed and completes the UI screen preparing process.

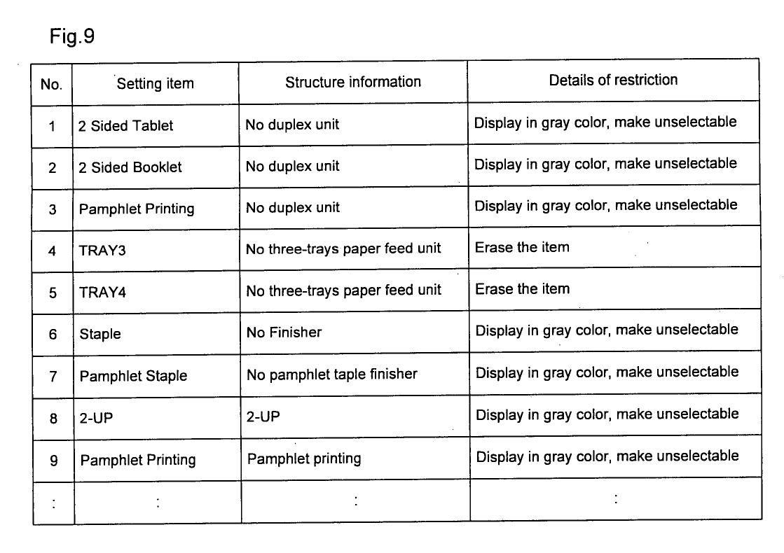

FIG. 9 is an explanatory view schematically illustrating an exemplary data structure of the UI combination restriction table 243. The UI combination restriction table 243 is a database which stores information about restriction on the combination of the structure and state of the MFP 204. Accordingly, the UI combination restriction table 243 includes details which depend on the MFP 204.

First, there will be described a process for restriction due to the structure of the MFP 204. In FIG. 9, a first row of “No.” indicates that, when a duplex unit is not mounted, “2 Sided Tablet” which is an option out of the items of “Duplex printing” is displayed in a gray color indicating that the option is unselectable, on the UI screen 300 in FIG. 8. In preparing the UI screen, the printer driver UI 204 refers to the UI combination restriction table 243 to check whether or not there is restriction on the respective setting items, and displays a UI screen appropriate to the structure of the MFP 204 for enabling making the print setting. Accordingly, in the case of the UI combination restriction table illustrated in FIG. 9, when the duplex unit is not mounted, the options of “2 Sided Booklet”, “2 Sided Tablet” and “Pamphlet Printing” are displayed in a gray color on the UI screen 300 to indicate that these options are unselectable. At this time, information as to whether the duplex unit is mounted/unmounted is included in the state information acquired by the MFP structure information acquisition section 244. The setting items defined in fourth and fifth rows are not included in the items to be displayed on the UI screen 300. These are setting items for other UI screens which are not illustrated.

Next, there will be described a process for restriction on the combination of functions. In FIG. 9, eighth and ninth rows of “No.” indicate that the combination of a setting of “2-up” out of the items of “N-up printing” and an option of “Pamphlet Printing” in “Duplex printing” should be prohibited. Namely, the eighth row indicates that, when “Pamphlet Printing” is selected in “Duplex printing”, the item “2-up” out of the items of “N-up printing” should be displayed in a gray color as an unselectable item. Also, the ninth row indicates that, when “N-up printing” is set to “2-up”, “Pamphlet Printing” in “Duplex printing” should be displayed in a gray color as an unselectable item.

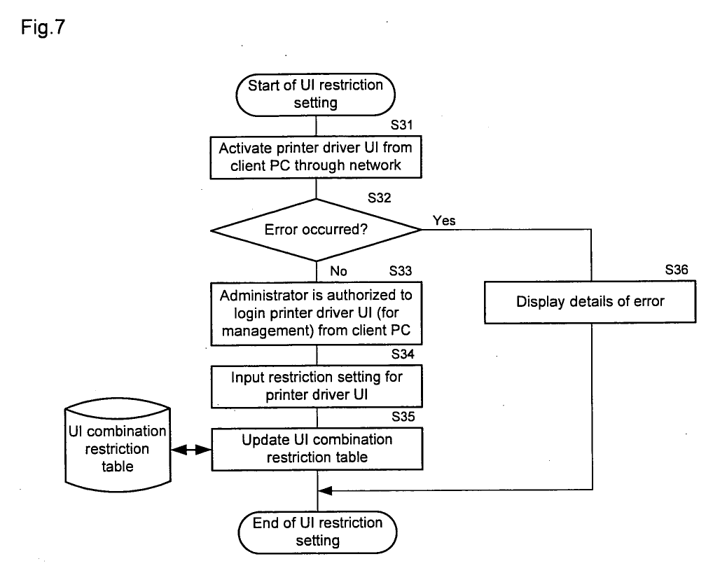

FIG. 7 is a flowchart illustrating a process procedure in the case where the setting change section 246 integrally changes the print settings. For example, it is assumed that a network administrator exerts certain restriction on the settable print settings on the UI screen prepared by the printer driver UI. The network administrator operates a setting changing application which is one of the applications 210 installed in the client PC 200 to access the printer driver UI 240. As illustrated in FIG. 7, the application 210 sends a request for execution of a setting changing process to the printer driver UI 240 through communication (step S31).

At this time, in the event of the occurrence of an error during the access to the printer driver UI 240, such as failure of the communication with the printer controller 203, the routine proceeds to step S36 where the setting changing application displays the details of the occurred error on the screen to inform the user it and then ends the process. On the other hand, when the access to the printer driver UI 240 has been successfully attained, the routine proceeds to step S33 where the setting changing application authorizes the administrator to log in the printer driver UI 240 and displays the screen for causing him or her to perform a setting changing process for the printer driver UI 240 (step S33). After the user logs in the printer driver UI 240 using a log-in screen, the setting changing application provides an operation environment for changing the print setting on the printer driver UI to cause the user to perform an operation for changing the print setting (step S34). Then, according to the changing operation, the content of the UI combination restriction table 243 is updated. Once the user completes required operations and inputs the completion of the changing operation, the setting changing application recognizes the request for completion and ends the changing process.

What is claimed is:

1. A printer driver comprising:
a user interface acquisition section for acquiring from an external print control device a user interface for allowing a user to make provisional print settings;
a set value transmission section for transmitting to the print control device the provisional print settings using the user interface; and
a print data generation section for acquiring ultimate print settings prepared on the basis of the provisional print settings transmitted to and in the print control device and for generating print data on the basis of the acquired ultimate print settings to transmit the print data to the print control device.

2. The printer driver according to claim 1, wherein the user interface acquisition section functions as a web browser and acquires the user interface prepared as a web page from the print control device.

3. The printer driver according to claim 1, wherein the user interface acquisition section acquires a user interface related to a structure of a print device for printing out the print data transmitted to the print control device.

4. An information processing device comprising the printer driver according to the claim 1.

5. A print control device comprising:
an information acquisition section for acquiring information on a structure or state of a print device for printing out print data;
a user interface management section for preparing a user interface which allows a user to make provisional print settings for printing out the print data by the print device on the basis of the acquired information, receiving from an external printer driver the provisional print settings using the prepared user interface, deciding ultimate print settings on the basis of the acquired information and the received provisional print settings, and providing the decided ultimate print settings to the printer driver;
a user interface supply section for providing the user interface prepared by the user interface management section to the printer driver; and
a print data processing section for acquiring print data generated by the printer driver on the basis of the ultimate print settings to make the print device to print out the print data.

6. The print control device according to claim 5, wherein the user interface supply section functions as a web server and provides the user interface prepared as a web page to the printer driver.

7. The print control device according to claim 5, wherein the user interface management section prepares the user interface according to the structure or state of the print device.

8. The print control device according to claim 5, further comprising a setting change section for changing an item or range of the print settings to be made using the user interface, and the user interface management section is constructed to prepare the user interface in which the item or range of the print settings is changed according to an instruction from the setting change section.

9. The print control device according to claim 5, wherein the user interface management section prepares a common user interface for printer drivers of a plurality of information processing devices that operate in different types of operating system environments.

10. A print data generating method for causing a computer to execute the steps of:
acquiring from an external print control device a user interface for allowing a user to make provisional print settings;
transmitting to the print control device the provisional print settings using the acquired user interface;
acquiring from the print control device ultimate print settings decided by the print control device on the basis of the transmitted provisional print settings; and
generating print data according to the acquired ultimate print settings.
